(19) United States
(12) Patent Application Publication
(10) Pub. No.: US 2008/0318511 A1
(43) Pub. Date: Dec. 25, 2008

(54) Ceiling wall and floor register assembly

(76) Inventor: Thomas V. Becker, Des Peres, MO (US)

Correspondence Address: Paul M. Denk, 763 S. New Ballas Road, St. Louis, MO, 63141, US

(21) Appl. No.: 12/157,560

(22) Filed: Jun. 11, 2008

Related U.S. Application Data
(60) Provisional application No. 60/936,367, filed on Jun. 20, 2007.

(51) Int. Cl. F24F 13/02; F16L 9/00

(52) U.S. Cl. 454/306; 138/177

(57) ABSTRACT

A ceiling wall and floor register assembly has interconnecting parts for the termination of an air duct and the parts purposefully lack mechanical or adhesive connections into the air flow. The parts interconnect with precisely tapered ends that cooperate and use a friction fit to resist jarring and separation during handling, construction, installation, and usage. Each part has an inlet face and an outlet face and at least one of the faces has a tapered end for connection to the opposite face of an adjacent part. The taper is generally upon the inside diameter of the selected end. The taper is applied to various parts of the assembly for a common method of installation. The assembly delivers treated air from a duct to a register without air loss through the connections of the assembly.

### CROSS REFERENCE TO RELATED APPLICATION

This non provisional patent application claims priority to the provisional patent application having Ser. No. 60/936,367, having filing date Jun. 19, 2007.

### BACKGROUND OF THE INVENTION

The ceiling and wall register assembly generally relates to heating, ventilating, and air conditioning systems and more specifically to the connection of duct joints without using mechanical or adhesive fasteners.

The prevalence of heated and air conditioned spaces has increased over the years. More and more, the air itself is heated, cooled, conditioned, and ventilated in structures of all kinds occupied by people. People occupy structures to protect themselves from the exterior environment. As the exterior environment changes with the seasons or has more temperature extremes, people seek to make the environment within a structure more comfortable. People have adjusted the interior environment with various heating and cooling devices over the years. At the present time, people often have a combined furnace and air conditioning unit in a residential setting.

The combined furnace and air conditioning unit has a heating portion for raising the interior temperature, typically in winter, and an air conditioning portion for cooling and drying the interior environment, typically in summer. The combined units, and stand alone air conditioning units, generally alter the temperature and humidity of air blown through the units. An electrically operated blower draws room air into the unit where it is heated or cooled as desired and then blows the treated air back into a structure, typically a house. The treated air moves into a house through a system of ductwork. The ductwork begins with a main duct generally extending the length of a house with branch ducts extending from the main duct for individual rooms where each duct generally terminates near a window. Older styles of ducts are generally sheet metal and have a hollow rectangular cross section, while newer ducts are round. Ducts terminate in a register that people see within a room as it releases treated air for the comfort of the room occupants.

### DESCRIPTION OF THE PRIOR ART

Existing registers generally have a rectangular shape with a perimeter flange that extends into an opening in a floor, wall, or ceiling, and then into the duct. Perpendicular to the perimeter flange, the register has a louvered surface that people see in their homes. The louvers extend perpendicular to the length of the register and have spacing between adjacent louvers for air flow out of the register as is commonly felt by home occupants. The register often has adjustable vanes below the louvered surface. People can adjust the vanes and partially close off a register as desired. The treated air from a register then mixes is with room air through convection.

However, louvers function as an obstruction to a flow of fluid, here treated air, generally heated or cooled. Louvers are known to reduce air flow exiting a register by 30% to 40% in volume per minute. The air flow reduction causes the heating and cooling system to operate longer and thus increase operating and maintenance costs for the system over time. People notice this in their utility bills, particularly at the seasonal adjustment times, the June electric bill and the November natural gas or heating oil bill. Additionally, the obstruction of the louvers disrupts the air flow and creates noise. Homeowners, particularly those sleeping or of tender year in age, have a sensitivity to noise and seek registers and other equipment that causes the least noise.

The present invention overcomes the disadvantages of the prior art and provides a register without louvers that mixes treated air unobtrusively. The assembly connects its components without mechanical fasteners entering the air flow as in existing sheet metal ducts.

### SUMMARY OF THE INVENTION

Generally, the present invention of a ceiling wall and floor register assembly has interconnecting parts for the termination of an air duct where the part to part connections do not use mechanical fasteners or adhesives that extend into the air flow of the parts. The parts of the invention interconnect using precisely tapered ends that cooperate in a friction engagement that resists jarring and separation during handling, construction, installation, and usage. Each part has an inlet face—receiving air—and an opposite outlet face—releasing air—and at least one of the faces has a tapered end for connection to the opposite face of an adjacent part. The parts of the assembly interconnect to deliver treated air from a duct to a register for a room without air loss through the connections of the assembly.

There has thus been outlined, rather broadly, the more important features of the invention in order that the detailed description thereof that follows may be better understood and that the present contribution to the art may be better appreciated. The present invention also includes a register, an elbow, a reducer, a bracket for connecting the assembly to the structure, a diverter connecting to the register, and a cap for closing the register, in place of the diverter. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a ceiling and wall register assembly for use with existing heating and air conditioning systems.

Another object is to provide such a ceiling and wall register assembly that connects adjacent parts that transfer air without mechanical fasteners, adhesives, or tapes.

Another object is to provide such a ceiling wall and floor register assembly that saves on head room, or vertical space, for low roof slope or other tight quarters installation.

Another object is to provide such a ceiling wall and floor register assembly that is made with non-metallic materials, preferably injection molded plastics.

Another object is to provide such a ceiling wall and floor register assembly that has a low cost of manufacturing so the consuming public can readily purchase the assembly and its component parts through existing retail outlets.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a top view of a register, the termination of the present invention, generally as seen when installed in a room;

FIG. 2 describes a side view of a register;

FIG. 3 is a sectional view of the register;

FIG. 4 describes a front view of an elbow of the present invention;

FIG. 5 shows a side view of the elbow;

FIG. 6 describes a sectional view of the elbow;

FIG. 7 illustrates an end view of a reducer looking from the narrow end—outlet—to the wide end—inlet;

FIG. 8 is a side view of the reducer;

FIG. 9 is a sectional view of the reducer;

FIG. 10 describes an end view of a narrower reducer, again looking from outlet to inlet;

FIG. 11 illustrates a side view of the narrower reducer;

FIG. 12 is a sectional view of the narrower reducer;

FIG. 13 is a bottom view of the bracket for installing the present invention to a structure;

FIG. 14 is side view of the bracket;

FIG. 15 is a top view of the dome like diverter that fits into the outlet of the register;

FIG. 16 is a side view of the diverter;

FIG. 17 is a sectional view of the diverter;

FIG. 18 is a top view of the plug that fits into the outlet of the register;

FIG. 19 is a side view of the plug; and,

FIG. 20 is a sectional view of the plug.

The same reference numerals refer to the same parts throughout the various figures.

### DESCRIPTION OF THE PREFERRED EMBODIMENT

The present art overcomes the prior art limitations by providing a ceiling wall and floor register assembly that connects its various components without mechanical fasteners, adhesives, or tapes. Beginning the description with what a person sees when the assembly is installed in a ceiling or wall, FIG. 1 shows a top view of a register 1. The register has a generally round shape with a perimeter flange 2 that has means to attach 3 the register to the structure of a building. The attachment means is generally screws that fit through fabricated openings 4 that penetrate through the thickness of the flange outside of the air flow through the assembly. The screws turn into a bracket, later described, and hold the register against the wall or ceiling of a room. Centered upon the flange and the register itself, an aperture 5 transmits air from the duct system into a room at either the ceiling or the wall. Preferably, the aperture is round for laminar air flow and serves as the outlet for air from the register.

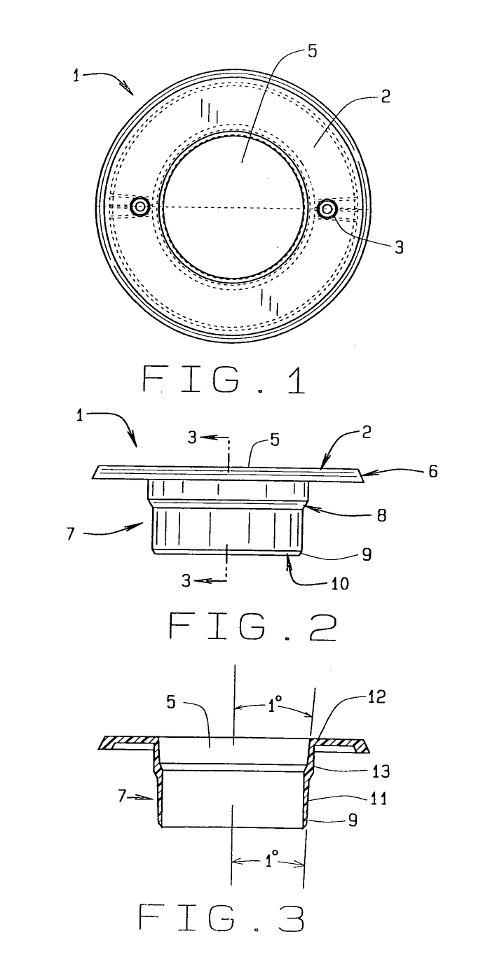

Turning the register, FIG. 2 shows the register from the side. The flange has a thickness and a beveled edge 6 that eases the transition to the ceiling or wall surface. Beneath the flange 2, the register has a hollow cylindrical tube 7 that has an inner diameter that defines the aperture 5. The cylindrical tube is shown with a step inwards in diameter, as at 8, from near the flange to approximately the middle of the tube, though a nearly constant diameter embodiment is foreseen. Opposite the flange, the tube has its narrow portion 9 that serves as the inlet for air to the register. The narrow portion has a beveled edge 10 to ease insertion of the tube into a preceding fitting or duct.

The essence of the invention is then shown in FIG. 3 as a sectional view of FIG. 2. The register 1 has a flange 2 having an integral tube 7, centered upon and perpendicular to the flange. The aperture 5 communicates with the tube to permit the flow of air through the register. The tube has a narrow portion 9 that has a round wall 11 that terminates in a beveled edge 10 opposite the flange 2. The round wall itself has a taper of one degree from proximate the midpoint of the length of the tube away from the flange towards the beveled edge. The taper reduces the outer diameter of the wall 11 and allows for a snug fit of this inlet into the outlet of a preceding fitting.

Within the aperture 5, the tube 7 has a wider section 12 with a rounded wall 13 as well. This rounded wall has a taper of one degree narrowing the diameter of the aperture away from the flange and towards the narrow portion 9 and terminating at the step 8, or approximately the midpoint of the height of the tube 7. The tapering of the wider section 12 receives a fitting and secures it without mechanical fasteners or adhesives, primarily using friction between the register and the fitting augmented by the taper of the wider section.

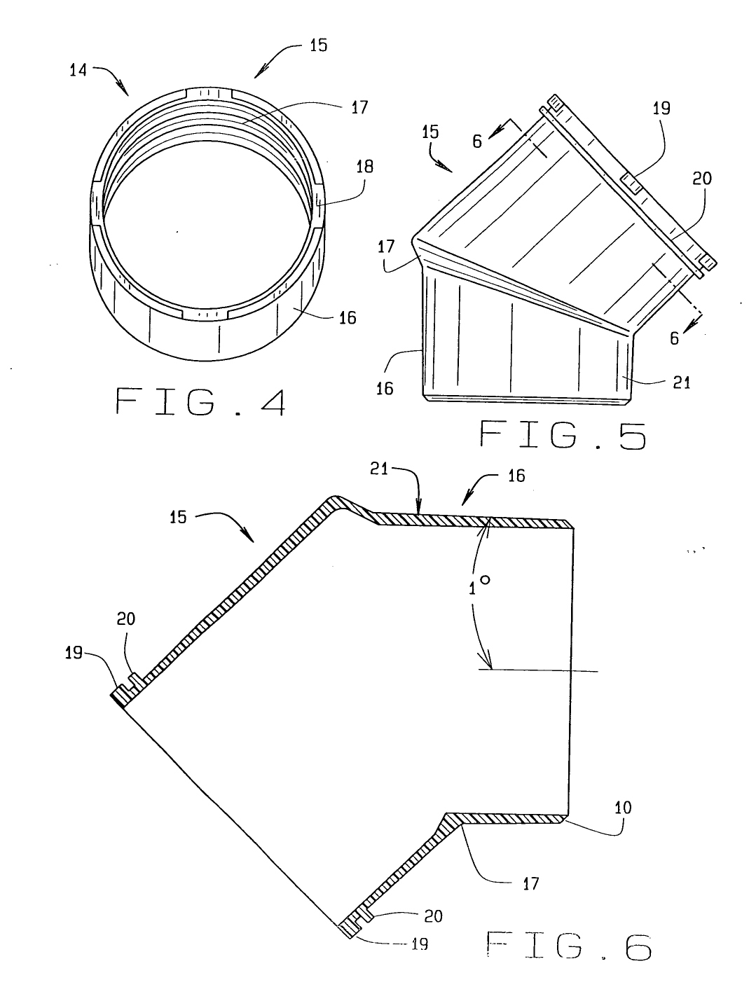

Inwardly from the register 1 in the present invention, FIG. 4 shows a front view of an elbow 14. The elbow is generally a hollow cylinder that has been bent, as at 17, approximately 45° generally at the center of the cylinder. The elbow has an inlet portion 15 that receives air from preceding ductwork or fittings and an opposite outlet portion 16. The inlet portion has a means to lock 18 upon a preceding fitting, such as the bracket as later described. Preferably, the locking means is of the bayonet type 19 that engages cooperatively with a preceding fitting. The bayonet lugs, as at 19, are spaced ahead of a ring 20 that serves as a stop for the preceding fitting. The ring in the preferred embodiment extends around the perimeter of the inlet portion 15. The inlet portion generally has a constant inside diameter as in FIG. 6. Opposite the inlet portion 15, the elbow has the outlet portion 16, here shown below the bend as at 17. The outlet portion has a smooth wall 21 with a tapering outer diameter.

FIG. 6 shows the elbow in section view where the inlet portion 15 has a constant inner diameter and the bayonet type locking means. The inlet portion transitions to the outlet portion 16 at the bend 17. From the bend outwardly, the outlet portion has an outer diameter that tapers at one degree from its widest at the bend to its narrowest at a beveled edge 10. The inner diameter of the inlet portion slightly exceeds the outer diameter of the outlet portion.

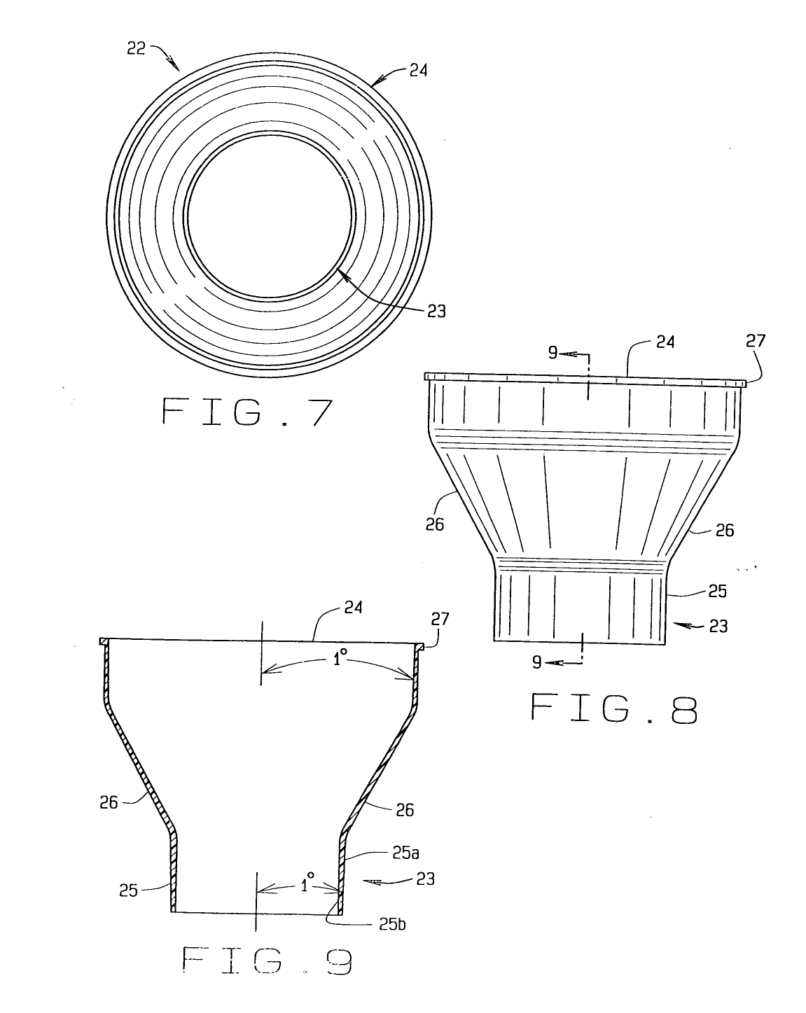

Often an elbow transitions a duct to the register in the near vicinity of the register. The elbow assists a duct passing through a wall or ceiling to mate with the register, more particularly the inlet portion, generally perpendicular to the wall or ceiling. As the elbow inlet 15 has a diameter proximate to the register aperture but less than the duct diameter, a reducer 22 connects the duct to the elbow and is shown in FIG. 7. The reducer has an outlet 23 here shown as a hollow round tube of a diameter slightly larger than the outsider diameter of the elbow inlet 15. The outlet has sufficient length to admit the inlet 15 and then the reducer expands in diameter as a frusto-conical shape to the reducer inlet 24. The reducer inlet is also round and hollow and has a greater diameter than the reducer outlet. The reducer inlet 24 connects to a duct of comparable shape and diameter. Though a round cross section for the inlet is shown, the reducer can also be fabricated with a rectangular inlet for connection to rectangular cross section ductwork.

The relationship of the diameters of the inlet 24 and the outlet 23 is shown in the side view of the reducer in FIG. 8. The outlet 23 has a hollow tube form with a smooth exterior wall 25. The outlet has a length to receive the inlet 15 securely. Then the outlet 23 transitions, or expands, in diameter to the diameter of the inlet 24. The transition in diameter appears as a frusto-conical shape here shown as two inclined surfaces 26. The transition is shown having a length along the longitudinal axis of the reducer of approximately one third the diameter of the inlet 24. The inlet also has a perimeter opposite the inclined surfaces 26 and the outlet 23. The perimeter has a lip 27 along the circumference of the inlet to assist installers in gripping the reducer and any attached elbow, register, or other component.

The reducer also secures firmly to the elbow, as at 15, with its outlet 23 in FIG. 9. The outlet has a wall 25 with a tapered exterior surface 25a of approximately one degree that narrows the outside diameter of the wall away from the center of the reducer towards the opening of the outlet 23. The wall 25 also has a tapered interior surface 25b of approximately one degree but that narrows the inside diameter of the wall. The taper of the interior surface, reducing the diameter of the outlet opening, grips the inlet 15 of the elbow and the friction between the reducer outlet 23 and the elbow inlet 15 secures the two parts without mechanical fasteners or adhesive. The narrowing taper of the elbow inlet 15 pinches with the narrowing taper of the interior surface 25b of the outlet 23.

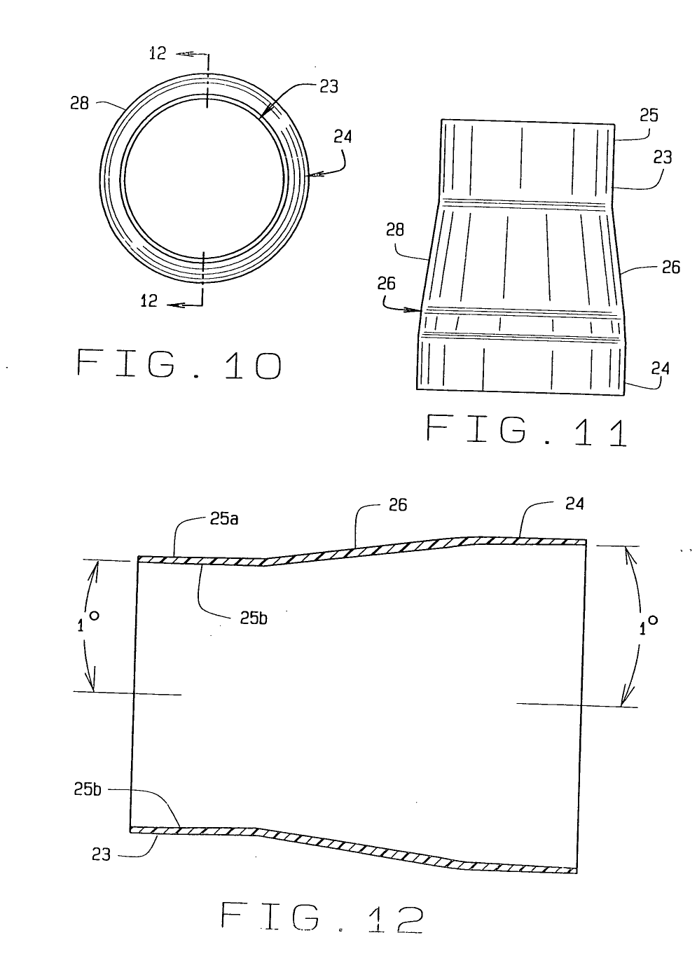

Reducers can transition between ducts and fittings of various diameters. FIG. 10 illustrates another reducer similar to FIG. 7 but with a smaller transition in diameter from inlet to outlet. This reducer 28 has an outlet 23 of a hollow round shape that communicates with a slightly larger inlet 24. As before, the outlet and inlet are round but can be formed in rectangular shapes to connect with similar shaped ducts. Turning the reducer on end, FIG. 11 shows a side view of this reducer 28 that generally shows a transition of approximately twenty percent from inlet diameter to outlet diameter. The hollow tubular inlet 24 connects to the also hollow tubular outlet 23 with inclined surfaces 26. In this reducer, the inclined surfaces have a shallower incline that in the previous reducer. The outlet though has a smooth wall 25 with a tapered cross section shown in FIG. 12.

As in the previous reducer, the outlet has a wall 25 with a tapered exterior surface 25a of approximately one degree that narrows the outside diameter of the wall away from the center of the reducer towards the opening of the outlet 23, here to the left of the figure. The wall 25 also has a tapered interior surface 25b of approximately one degree that narrows the inside diameter of the outlet. The taper of the interior surface reducing the diameter of the outlet opening grips an inlet 15 of the elbow where the friction between the outlet 23 and the elbow inlet 15 secures the two parts. Though an elbow to reducer connection is described, the outlet can connect to other fittings of complementary shape. The narrowing taper of the inlet 15 pinches with the narrowing taper of the interior surface 25b of the outlet 23 for a snug fit between two components of the assembly.

With an elbow generally terminating a duct for connection to register and the register being visible to occupants of a room, the assembly 1 generally secures to the building structure, such as a ceiling joist or truss chord. Securing the elbow to the structure prevents inadvertent movement of the register during air speed and volume changes through connected ducts, and expansion and contraction of metal ductwork. A secure register prevents damage to adjacent room finishes such as drywall or in some cases plaster. As building structure has standard shapes, generally rectangular, and without a taper, the assembly connects to a joist or truss chord with mechanical fasteners. The mechanical fasteners generally have heads upon threaded shanks where the shanks embed into a joist or truss, wood screws and machine bolts are preferred fasteners. The heads of the fasteners connect with a boot bracket 29 shown from above in FIG. 13.

As in FIG. 13, the boot bracket has a central plate 30, generally rectangular, and here shown as square with four sides. The plate has an upper surface 30a, generally away from a register, and an opposite lower surface 30b towards the register. The plate is generally thin in cross section and has a perimeter edge reinforced with a band 31. The band is shown upon three sides of the plate and is generally perpendicular to the plane of the plate. The plate has a centered opening 32, generally round that accepts the outlet 15 of the elbow. The centered opening has at least one bayonet type lock 33, here shown as four, that engage the bayonet lugs 19. The ring 20 of the outlet then abuts the upper surface 30a of the plate 30. The bayonet type locks, cooperating with the lugs, previously shown in FIG. 5, allow the elbow 14 to achieve various angles relative to the building structure. The elbow, through a reducer, allows a duct to connect, generally from parallel to perpendicular, to the building structure. Finer angle adjustments of the elbow, to the building structure, can be made with a higher number of lugs and bayonet locks, or more precisely located bayonet locks for specific angles, as desired. Generally, the elbow permits a duct to approach the register from at least four angles.

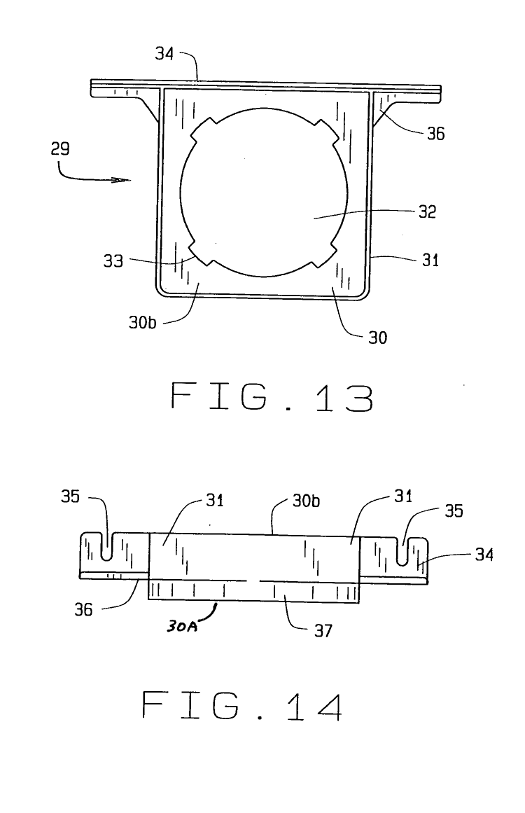

Returning to the perimeter of the central plate, the fourth side is enclosed by a flange 34, also perpendicular to the plane of the central plate. The flange, as shown in FIG. 14, has a generally elongated rectangular shape of similar depth to the height of the band and two ends. Upon each end, the flange has a notch 35 partially through the depth of the flange. The notch allows the boot bracket 29 to rest upon the shanks of the mechanical fasteners and the heads to extend outward from the notch and to grasp the flange and pull the boot bracket to the building structure for securement. The junction of the flange to the corner of the plate may be reinforced by a gusset 36 in the plane of the central plate. Beneath the band 31, a sleeve 37 extends below the perimeter of the opening 32. The sleeve, generally hollow, has a constant inside diameter that receives the tapered tube 7 of the register. The sleeve generally joins to the upper surface 30a.

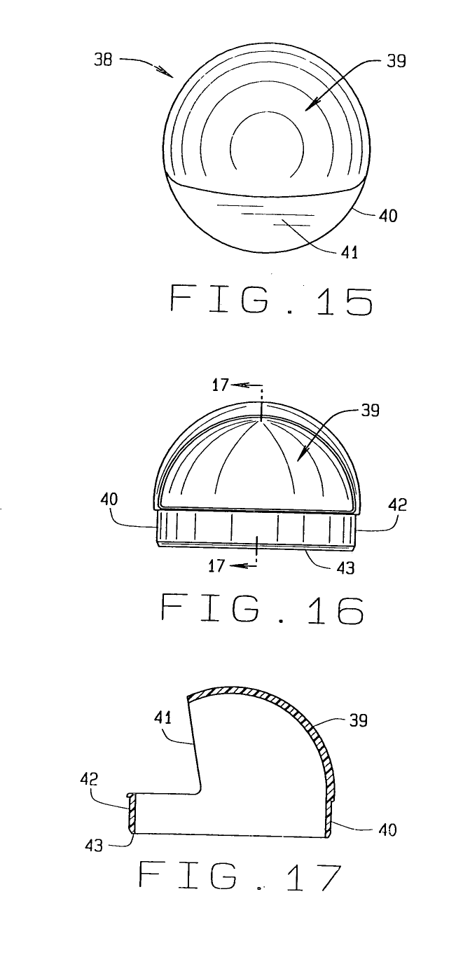

With the assembly 1 secured to the structure from the register 1 to the ducts and the finish applied to a room, an occupant of the room may adjust the register for a directed air flow. By the addition of the direction the register is primarily an opening flush with a ceiling, wall, or floor, with the air directed straight out of the register. The diverter 38 shown in FIG. 15 allows a room occupant to direct air flow from a register in a desired direction. The diverter has a partial dome 39 upon a round cylindrical end 40. The dome has a generally round shape that occupies more than 180° of the perimeter of the end and a radius that occupies over 90° upwardly from the plane of the end as later shown in FIG. 17. As the dome extends only partially, the diverter has an opening 41 that transmits air therethrough from the register to a room.

Viewing the diverter 38 from the rear, FIG. 16 shows the dome 39 extending across the diameter of the end 40. The radius of the dome is generally similar to that of the end. The dome joins with the end so the perimeter of the dome matches a wall 42 that defines the end 40. The wall forms a hollow cylinder and is generally tangent to the dome at all points around the perimeter of the dome. The wall in this embodiment has a constant thickness and no tapering. The wall has its own beveled end as at 43 opposite the dome. This beveled end 43 fits into the outlet 5 of the register.

In section, the diverter 38 appears as a partial hemisphere in FIG. 17. The dome 39 rests upon the wall 42 that forms the end 40 of the diverter. The dome extends from one wall upwardly and beyond ninety degrees in rotation from the top of the wall. The incomplete extent of the dome provides an opening as at 41 that distributes air from the register into a room. The opening, in cooperation with the fit of the end into the outlet 5, allows a person to turn the diverter and direct air flow as desired.

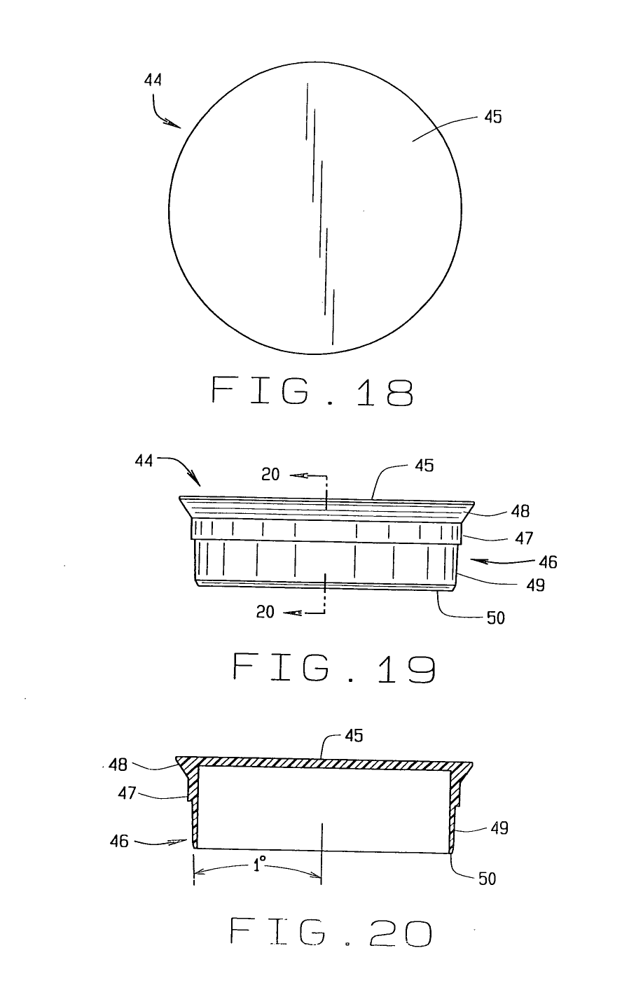

When a person wants to stop air flow from a register into a room, the person uses the plug shown in FIG. 18. The plug 44 has a generally round shape, slightly larger in diameter than the register outlet 5. The plug has its primary part as a disk 45. Beneath the disk, FIG. 19 shows the plug has a tapered cylindrical inlet as at 46. The inlet has slightly less diameter than the disk and fits snugly into the opening of the register. The inlet may have a step outward in diameter as at 47 and then an expansion outward of diameter in a transition to the disk as at 48. The inlet is generally a hollow cylinder formed of a wall 49 with a beveled end 50.

And, FIG. 20 shows a section through the plug illustrating the construction of the plug. The disk 45 joins to the inlet 46 and the inlet transitions in diameter at 48 and then steps inwardly in diameter as at 47. Below the step, the inlet has the wall 49, here shown as two spaced apart sections. Below the step, the wall tapers in its outside diameter so that the wall narrows in diameter at a rate of one degree. Opposite the disk, the wall 49 attains its narrowest diameter proximate the beveled end 50. This one degree taper provides a snug fit of the plug into the outlet 5 of the register similar to the other fitting having tapered inlets and outlets as previously described. The tapering of the inlets and outlets allows of construction of this assembly without the use of mechanical fasteners or adhesives in fittings from ducts to the registers.

From the aforementioned description, a ceiling wall and floor register has been described. The device is uniquely capable of connecting two adjacent fittings using a friction fit of at least one tapered fitting with mechanical fasteners or adhesives. The tapered is generally a narrowing of the outside diameter of one fitting and the narrowing of the inside diameter of a second fitting. Generally the taper is approximately 0.5 degree to approximately two degrees and preferably one degree with the narrowest portion at the outside end of a fitting. The assembly and its various components may be manufactured from many materials, including but not limited to, wood, steel, aluminum, polymers, ABS plastic, polyvinyl chloride, high density polyethylene, polypropylene, nylon, rubber, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Heretofore, those skilled in the art have not recognized tapered ends as suitable for connections of adjacent parts in ductwork. Therefore, the claims include such equivalent constructions insofar as they do not depart from the spirit and the scope of the present invention.

I claim:

1. An assembly for conveying treated air from a duct into a room without loss of air therethrough, comprising:
a register, delivering air into the room, generally hollow and having a tapered end; and,
at least one tubular member connecting said register to the duct, having at least one tapered end.

2. The conveying assembly of claim 1 further comprising:
said register having a hollow cylindrical form, an inlet and an opposite outlet, said inlet including said tapered end and said outlet having a round opening.

3. The conveying assembly of claim 2 further comprising:
a plug, generally round, and suitable for fitting snugly within said opening of said register, and having the capability of blocking the flow of air through said register; and,
a diverter, generally round and partially domed, the radius of said diverter also being the radius of the domed portion thereof, and suitable for fitting within said opening of said register, and having the capability of directing the flow of air into the room.

4. The conveying assembly of claim 1 further comprising:
said at least one tubular member including at least one elbow and at least one reducer;
said elbow having an inlet and an outlet where the central axis of said inlet is at an angle to the central axis of said outlet, and said inlet having a tapered end; and,
said reducer having an inlet and an outlet where said inlet and said outlet share a common longitudinal axis, said inlet having a greater diameter than said outlet and said outlet having a tapered end.

5. The conveying assembly of claim 1 further comprising:
a bracket for securing said assembly to the structure of a room, having a generally planar plate with a centered opening, and a flange offset from said centered opening and generally perpendicular to said plate, said flange having four spaced apart notches.

6. The conveying assembly of claim 1 further comprising:
said elbow having an inlet and an outlet where the central axis of said inlet is at an angle to the central axis of said outlet, said inlet having a tapered end and said outlet having a plurality of lugs spaced upon the circumference; and,
a bracket for securing said assembly to the structure of a room, having a generally planar plate with a centered opening, said plate having a plurality of slots corresponding to said lugs in said outlet to engage said outlet to said bracket by a bayonet type lock, and a flange offset from said centered opening and generally perpendicular to said plate, said flange having two spaced apart notches.

7. The conveying assembly of claims 1, 2, 4, or 6, further comprising:
said tapered end having a taper of approximately 0.5 degree to approximately 2 degrees.

8. The conveying assembly of claim 7 wherein said tapered end has a taper of approximately 1 degree.
